(19) United States
(12) Patent Application Publication
(10) Pub. No.: US 2016/0366230 A1
(43) Pub. Date: Dec. 15, 2016

(54) TECHNIQUES FOR IDENTIFYING SOURCE LINKS FOR APPLICATION DOWNLOADS

(71) Applicant: Doat Media Ltd., TEL AVIV (IL)

(72) Inventor: Noam YASOUR, London (GB)

(73) Assignee: Doat Media Ltd., TEL AVIV (IL)

(21) Appl. No.: 15/180,562

(22) Filed: Jun. 13, 2016

Related U.S. Application Data
(60) Provisional application No. 62/175,336, filed on Jun. 14, 2015.

(51) Int. Cl. H04L 29/08; G06Q 30/02; G06F 17/30

(52) U.S. Cl. CPC H04L 67/146; H04L 67/02; H04L 67/10; G06F 17/30887; G06Q 30/0277; G06Q 30/0242

(57) ABSTRACT

A system and method for identifying source links of application downloads are presented. The system includes identifying a download of an application on a user device; analyzing a plurality of previous requests sent from the user device to determine an application sequence that resulted in the identified application download, wherein the application sequence includes at least a request to download the application by the user device; analyzing the identified application download sequence to determine a referrer identifier; and identifying, based at least on the referrer identifier, a source link of the application download sequence.

### CROSS-REFERENCE TO RELATED APPLICATIONS

This application claims the benefit of U.S. Provisional Application No. 62/175,336 filed on Jun. 14, 2015, the contents of which are hereby incorporated by reference.

### TECHNICAL FIELD

The present disclosure relates generally to downloading applications, and more particularly to identifying source links for downloaded applications.

### BACKGROUND

Hundreds of thousands of mobile applications are currently available on various web sources and data repositories such as, for example, the AppStore®, Google Play®, and the like. Such web sources typically allow for discovery tools that aid users seeking to download a particular mobile application or type of mobile application. These discovery tools may include constructed search bars, categorized menus, classifiers, and so on.

Developers, distributors, and owners of mobile applications commonly provide links (in the form of, e.g., uniform resource locators). Each link may be activated to redirect a user to an application repository, thereby allowing the user to download the corresponding mobile application. Often, these links may be associated with a clickable banner, thereby allowing a user to download the mobile applications after clicking on the banner. In particular, such a banner may be an advertisement presented over the web (e.g., a web page for a blog may include or display banners for mobile applications owner by the blog's sponsors). Identifying which link directed the user to an application repository from which the user downloaded an application may be beneficial for various reasons such as, but not limited to, verifying advertising click-through-rates.

Also, rather than linking directly to an application repository through which the associated mobile application can be downloaded, such a link often redirects to another web source as part of a verification process utilized to confirm that the application was downloaded after interaction with the link. Such verification information may be valuable to the developer or owner of the application, thereby allowing them to confirm the effectiveness of the banner or other presentation of the link based on numbers of times each application is downloaded after interaction with the link.

The redirections are often subject to errors when network interruptions and disconnections from the network occur. If such an error occurs, determination of the source link that was activated, thereby ultimately leading to the application download cannot be identified. Consequently, verification of link-based downloads of mobile applications using redirections often results in inaccurate data regarding such application downloads.

Additionally, some web sources include links that automatically redirect users to applications repositories, particularly affecting users of mobile devices. Such automatic redirections consume computing resources, may introduce security vulnerabilities to such devices, and may frustrate users who are directed away from content they wished to view. Identifying sources of such automatic redirections would be useful in blocking or otherwise mitigating such automatic redirections.

It would therefore be advantageous to provide a solution that would overcome the deficiencies of the prior art.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

Some embodiments disclosed herein include a method for identifying source links of application downloads. The method comprises identifying a download of an application on a user device; analyzing a plurality of previous requests sent from the user device to determine an application sequence that resulted in the identified application download, wherein the application sequence includes at least a request to download the application by the user device; analyzing the identified application download sequence to determine a referrer identifier; and identifying, based at least on the referrer identifier, a source link of the application download sequence.

Some embodiments disclosed herein include a system for identifying source links of application downloads. The system comprises a processing system; and a memory, the memory containing instructions that, when executed by the processing system, configure the system to: identify a download of an application on a user device; analyze a plurality of previous requests sent from the user device to determine an application sequence that resulted in the identified application download, wherein the application sequence includes at least a request to download the application by the user device; analyze the identified application download sequence to determine a referrer identifier; and identify, based at least on the referrer identifier, a source link of the application download sequence.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a flowchart illustrating a method for identifying source links of application downloads according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for identifying source links for application downloads. A download of an application to a user device is identified and previous requests for applications by the user device are identified. The previous requests are analyzed. Based on the analysis and any redirections related to the previous requests, an application download sequence is determined. Based on the determined application download sequence, a source link is identified.

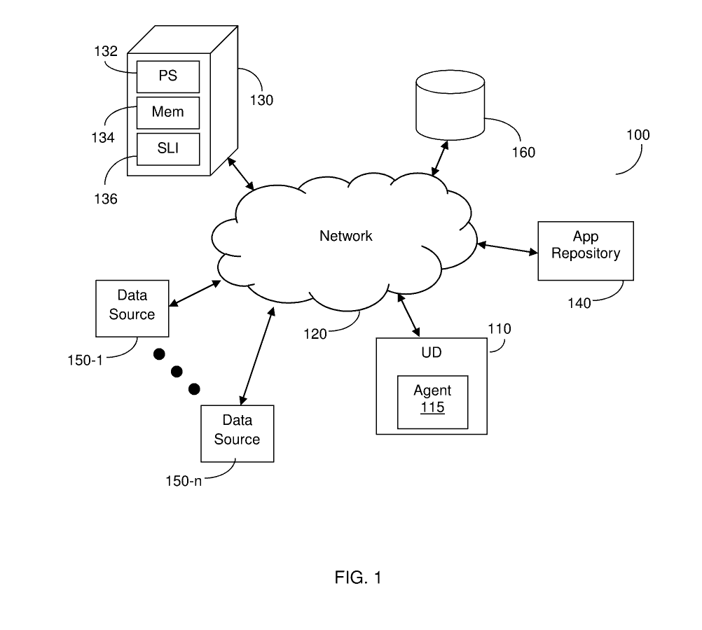

FIG. 1 shows an example network diagram 100 utilized to describe the various disclosed embodiments. The network diagram 100 includes a user device 110, a network 120, a server 130, an application (app) repository 140, a plurality of data sources 150-1 through 150-n (hereinafter referred to individually as a data source 150 and collectively as data source 150, merely for simplicity purposes). In some embodiments, the network diagram 100 further includes a database 160. In some embodiments, the database 160 includes information related to source links including, but not limited to, domains, types (e.g., application repository, web page advertisement, link, email-based advertisement, QR code scan, etc.), time pointers, and so on.

The network 120 may be, but is not limited to, a local area network (LAN), a wide area network (WAN), a metro area network (MAN), the world wide web (WWW), the Internet, a wired network, a wireless network, similar networks, and the like, as well as any combination thereof. Each of the data sources 150 may be, but is not limited to, an application repository, a server of a web page owner, and the like.

The user device 110 may be, but is not limited to, a smart phone, a mobile phone, a laptop, a tablet computer, a wearable computing device, a personal computer (PC), a smart television, and the like. The user device 110 may execute or have installed therein an agent 115 which may be, but is not limited to, an application.

The user device 110 is configured to enable downloading of applications from, e.g., the application repository 140 via the network 120. The application repository 140 is typically a web source hosting a plurality of applications. Example application repositories include, but are not limited to, the Apple® app store, Google Play®, the Amazon® app store, the Microsoft® app store, and the like. The communication between the user device 110 and the application repository 140 may be over a hypertext transfer protocol (HTTP), HTTP secure (HTTPS) protocol, or other encrypted or unencrypted protocols. Upon receiving a request to download an application from the user device 110, the application repository launches a link to one of the web sources 150 from which the application is downloaded to the user device 110.

An application may be, but is not limited to, a mobile application, a virtual application, a web application, a native application, a cloud application, and the like. Examples for an application may be, but is not limited to, an e-commerce application, a social media application, an enterprise application, a gaming application, a media sharing application, a storage application, a software development application, and so on.

A user of the user device 110 may initiate a sequence of events ending with a request to download an application through the application repository 140 or through a banner or other content associated with a link directed to a location in the application repository 140 through which the requested application can be downloaded. The application download sequence may be initiated in response to, e.g., the user tapping or clicking on the link-associated content displayed over the user device 110. In an embodiment, the request may be a HTTP request including a URL pointing to a particular location in the application repository 140 as well as a referrer identifier indicating the address (e.g., the URL) of the web page or link-associated content linking to the requested application.

The user device 110 may send the request to the application repository 140, and an application download resulting from the request may be detected by the agent 115. In response to detection of a download on the user device 110, the agent 115 may send a notification to the server 130. The notification may include the request and an identifier of the user device 110. The identifier of the user device 110 may be, but is not limited to, an identification (ID) number, an IP address, and the like.

In an embodiment, the server 130 may be configured to analyze previous requests for application downloads sent by the user device 110 to determine a sequence of events that resulted in the identified application download. Specifically, the server 130 may be configured to identify a most recent request and to identify a source link, i.e., a link whose activation resulted in a sequence of events ending with the application download. In an embodiment, the server 130 may be configured to analyze the previous requests when the agent 115 sends a notification regarding a download of an application.

To this end, in an embodiment, the server 130 is configured to retrieve a plurality of previous requests sent from the user device 110 based on the identifier of the user device 110 and to identify the most recent request for an application download. In a further embodiment, the server 130 is configured to analyze the request to identify a source link that is linked to the most recently requested application via the source link identifier (SLI) 136. In an embodiment, analyzing the request may include, but is not limited to, determining a referrer identifier included in the request and determining, based on the referrer identifier, an address of the source link. In an example embodiment, the determination of the address of the source link may include comparing the determined referrer identifier to identifiers of data sources associated with the redirections.

In another embodiment, the server 130 may be further configured to determine one or more advertisement identifiers associated with an advertisement source link. The advertisement identifiers may include, but are not limited to, geographic regions, publisher names, servicing company names, and the like. The server 130 may be configured to further store the advertisement identifiers in the database 160.

As a non-limiting example, when an application download sequence includes a first redirection from an advertisement in an entertainment application to a web page and a second redirection from the web page to an application repository from which an application download of a cooking application is ultimately requested, the identified source link may be a link to the entertainment application advertisement. Specifically, the source link may be identified by analyzing the request to determine a value of a HTTP referrer identifier designated in a HTTP header field of the request, the identified HTTP referred identifier indicates an address (e.g., a URL) of the advertisement in the entertainment application that is linked to the downloaded

The server 130 may be further configured to save data associated with the identified source link in, e.g., the database 160. As noted above, such data may include, but is not limited to, a domain of the source link, a type of the source link (e.g., application repository, web page advertisement, link, email-based advertisement, QR code scan, etc.), a time pointer indicating a time of the source link, and so on

The analysis of the application download sequence allows for determination of downloads even if some information in the application repository 140 is hidden, i.e., inaccessible to the server 130. Additionally, the analysis may allow for accurate determination of application downloads when the attribution or verification of the download was interrupted by loss of connection, changes in the network 120, and the like. Thus, the identification of the source link based on the redirection sequence allows for improved accuracy of application download determinations.

It should be noted that the server 130 typically includes a processing system (PS) 132 coupled to a memory (mem) 134. The processing system 132 may comprise or be a component of a processor (not shown) or an array of processors coupled to the memory 134. The memory 134 contains instructions that can be executed by the processing system 132. The instructions, when executed by the processing system 132, cause the processing system 132 to perform the various functions described herein. The one or more processors may be implemented with any combination of general-purpose microprocessors, multi-core processors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system 132 may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

It should be further noted that a single user device 110 and a single application repository 140 are shown in FIG. 1 merely for simplicity purposes and without limitation on the disclosed embodiments. Multiple user devices and application repositories may be communicatively connected to the server 130 over the network 120 without departing from the scope of the disclosure.

It should also be noted that the source link identifier 136 is shown as being included in the server 130 merely for simplicity purposes and without limitation on the disclosed embodiments. The source link identifier 136 may be separate from and/or communicatively connected to the server 130 (e.g., over the network 120) without departing from the scope of the disclosure.

It should be understood that the embodiments disclosed herein are not limited to the specific architecture illustrated in FIG. 1, and other architectures may be equally used without departing from the scope of the disclosed embodiments. Specifically, the server 130 may reside in a cloud computing platform, a datacenter, and the like. Moreover, in an embodiment, there may be a plurality of servers operating as described hereinabove and configured to either have one as a standby, to share the load between them, or to split the functions between them.

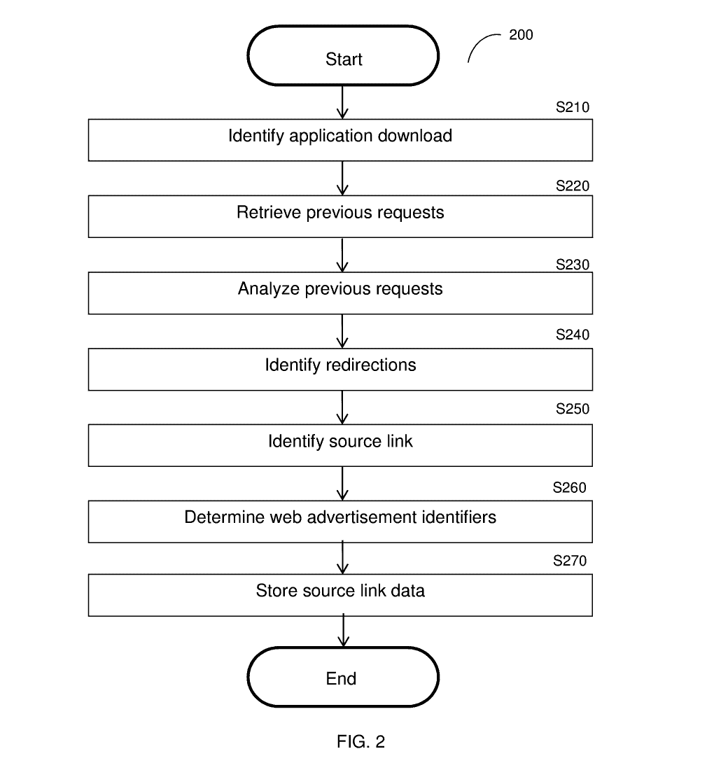

FIG. 2 is an example flowchart 200 illustrating a method for identifying source links for application downloads according to an embodiment. In an embodiment, the method may be performed by a server (e.g., the server 130) via, at least in part, a source link identifier (e.g., the source link identifier 136).

At S210, a download of an application on a user device is identified. In an embodiment, the download may be identified based on a notification sent by an agent installed on the user device. The agent may determine the download by, e.g., detecting an application file sent to the user device. Alternatively, the download may be identified based on monitoring of application downloads from, e.g., a particular application repository or repositories. Identifying the application download may be further based on, but not limited to, a file extension of the file. As a non-limiting example, a file having a “.ipa” extension may be detected as an application file because a “.ipa” extension is associated with iPhone® applications.

At S220, previous requests for application downloads sent by the user device are identified. In an embodiment, the previous requests may be retrieved from, e.g., the agent installed on the user device. In a further embodiment, the agent monitors requests sent by the user device and identifies application downloads occurring after sending of the monitored requests. In another embodiment, the previous requests may only include requests initiated within a predetermined time period (e.g., requests within the last 30 seconds).

At S230, the determined previous requests are analyzed. In an embodiment, the analysis may include identifying a most recent request directed to an application repository. In another embodiment, the analysis may include identifying application downloads occurring after sending of the previous requests. In yet another embodiment, the analysis may further include determining a time of the sending of each request.

At S240, based on the analysis of the previous requests, one or more redirections may be identified. The redirections may include, but are not limited to, URL-based redirections, other link-based redirections, or any other redirection from one data source to another before download of the application. To this end, each redirection may be associated with a source initiating the redirection. The source may be, for example, a landing web page, an advertisement (e.g., in-app), and so on.

In an embodiment, the identified redirections may include all link-based events in the application download sequence beginning at interaction with a source link and ending with the application download. In a typical embodiment, the application download sequence may be organized chronologically based on time pointers for, e.g., activations of links associated with the identified redirections, sending of a request for the downloaded application, or both.

At S250, the application download sequence is analyzed to identify the source link. In an embodiment, the analysis may include, but is not limited to, analyzing the request to determine a referrer identifier and comparing the determined referrer identifier to identifiers of data sources associated with the redirections. The source link may be identified as a link associated with an identifier matching the referred identifier. If no redirections occurred, the source link may be identified as a link to the location of the application in the application repository (i.e., a direct download from the application repository).

In a further embodiment, S250 may further include determining information related to the identified source link such as, but not limited to, domain, type (e.g., application repository, web page advertisement, link, email-based advertisement, QR code scan, etc.), time pointer indicating a time of activation of the source link, and so on.

The analysis in S250 may include parsing URLs and/or HTTP requests and/or responses captured by the agent. Typically, the required information can be founder in the headers of such requests/responses.

At optional S260, if the source link is a source link of a web page advertisement, at least one web page advertisement identifier may be determined. The advertisement identifiers may include, but are not limited to, geographic regions, publisher names, servicing company names, and the like. At optional S270, the source link, the source link information, the web advertisement identifiers, or a combination thereof, may be stored in, e.g., a database (e.g., the database 160).

As a non-limiting example, a user of a user device may be presented with a pop-up advertisement while using a game application. Upon clicking the pop-up, the user is redirected to a web page before being directed to an application repository from which a news application can be downloaded.

When the news application is downloaded to the user device, the download of the news application is identified based on data from an agent installed on the user device. Previous requests for applications sent by the user device are determined and analyzed to identify the most recent request, i.e., the request for the news application. The first redirection from the game application to the web page and the second redirection from the web page to the application repository are identified. An application download sequence including the activation of a first link associated with the first redirection, the activation of a second link associated with the second redirection, and a request to download the news application is analyzed. The analysis includes determining a URL of the pop-up advertisement indicated by a HTTP referrer value in a HTTP header of the request. Based on the analysis, first link, is identified as the source link.

It should be noted that the example discussed herein above with respect to FIG. 2 is described with respect to a single redirection merely for simplicity purposes and without limitation on the disclosed embodiments. Source links for application download sequences including multiple redirections may be determined without departing from the scope of the disclosure. In a typical embodiment, when multiple redirections are included in an application download sequence, the source link will be the link of the first redirection in the application download sequence.

It should be noted that several embodiments described herein are discussed with respect to analyzing a sequence of events including redirections merely for simplicity purposes and without limitation on the disclosure. The disclosed embodiments may be equally utilized to identify source links when no actual redirections occur.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for identifying source links of application downloads, comprising:
identifying a download of an application on a user device;
analyzing a plurality of previous requests sent from the user device to determine an application sequence that resulted in the identified application download, wherein the application sequence includes at least a request to download the application by the user device;
analyzing the identified application download sequence to determine a referrer identifier; and
identifying, based at least on the referrer identifier, a source link of the application download sequence.

2. The method of claim 1, wherein the application download sequence further includes at least one redirection, wherein each redirection is associated with a redirection source identifier, wherein determining a source link for the application download further comprises:
comparing each redirection source identifier to the referrer identifier to identify a matching data source identifier; and
determining, based on the comparison, the source link, wherein the source link is associated with the matching data source identifier.

3. The method of claim 2, wherein each redirection source identifier indicates any of: a web page, and a web advertisement.

4. The method of claim 1, wherein determining the referrer identifier further comprises:
analyzing the request to determine the referrer identifier.

5. The method of claim 4, wherein the request includes a header, wherein the referrer identifier is determined based on the header.

6. The method of claim 5, wherein the header is a hypertext transfer protocol (HTTP) header field including a HTTP referrer value, wherein the referrer identifier is further determined based on the referrer value.

7. The method of claim 1, wherein the application download is identified based on a notification sent by an agent installed on the user device.

8. The method of claim 1, further comprising:
determining information of the identified source link, wherein the information includes at least one of: a domain, a type, and a time pointer.

9. The method of claim 1, further comprising:
determining whether the application download sequence includes at least one redirection; and
upon determining that the application download sequence does not include at least one redirection, determining that the application download was a direct download from an application repository.

10. A non-transitory computer readable medium having stored thereon instructions for causing one or more processing units to execute the method according to claim 1.

11. A system for identifying source links of application downloads, comprising:
a processing system; and
a memory, the memory containing instructions that, when executed by the processing system, configure the system to:
identify a download of an application on a user device;
analyze a plurality of previous requests sent from the user device to determine an application sequence that resulted in the identified application download, wherein the application sequence includes at least a request to download the application by the user device;
analyze the identified application download sequence to determine a referrer identifier; and
identify, based at least on the referrer identifier, a source link of the application download sequence.

12. The system of claim 11, wherein the application download sequence further includes at least one redirection, wherein each redirection is associated with a redirection source identifier, wherein the system is further configured to:
compare each redirection source identifier to the referrer identifier to identify a matching data source identifier; and
determine, based on the comparison, the source link, wherein the source link is associated with the matching data source identifier.

13. The system of claim 12, wherein each redirection source identifier indicates any of: a web page, and a web advertisement.

14. The system of claim 11, wherein the system is further configured to:
analyze the request to determine the referrer identifier.

15. The system of claim 14, wherein the request includes a header, wherein the referrer identifier is determined based on the header.

16. The system of claim 15, wherein the header is a hypertext transfer protocol (HTTP) header field including a HTTP referrer value, wherein the referrer identifier is further determined based on the referrer value.

17. The system of claim 11, wherein the application download is identified based on a notification sent by an agent installed on the user device.

18. The system of claim 11, wherein the system is further configured to:
determine information of the identified source link, wherein the information includes at least one of: a domain, a type, and a time pointer.

19. The system of claim 11, wherein the system is further configured to:
determine whether the application download sequence includes at least one redirection; and
upon determining that the application download sequence does not include at least one redirection, determine that the application download was a direct download from an application repository.
